(19) United States
(12) Patent Application Publication
(10) Pub. No.: US 2008/0093217 A1
(43) Pub. Date: Apr. 24, 2008

(54) Method for arranging nanoparticles by way of an electric field, structures and systems therefor

(76) Inventors: Wei Wu, Mountain View, CA (US); R. Stanley Williams, Portola Valley, CA (US); Shih-Yuan Wang, Palo Alto, CA (US); Philip J. Kuekes, Menlo Park, CA (US); Zhiyong Li, Redwood City, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,678

(22) Filed: Oct. 20, 2006

(51) Int. Cl. G01N 27/26

(52) U.S. Cl. 204/450; 435/287.2; 977/902

(57) ABSTRACT

A method of forming a plurality of NERS-active structures is disclosed. Particularly, a substrate having a surface and a liquid including nanoparticles is deposited on at least a portion of the surface of the substrate. At least one electric field may be generated proximate to the surface and at least a portion of the nanoparticles may be arranged via the electric field. A system includes at least two electrodes configured for producing at least one electric field for substantially arranging nanoparticles substantially according to a selected pattern. A NERS-active structure includes a substrate and a plurality of features located at predetermined positions on a surface of the substrate and at least one NERS-active nanoparticle at least partially embedded therein.

### FIELD OF THE INVENTION

The invention relates to surface enhanced Raman spectroscopy (NERS). More particularly, the invention relates to NERS-active structures including features having nanoscale dimensions, methods for forming NERS-active structures, methods for forming NERS-active structures, and methods for performing NERS using NERS-active structures.

### BACKGROUND OF THE INVENTION

Raman spectroscopy is a well-known technique for performing chemical analysis. In conventional Raman spectroscopy, high intensity monochromatic light provided by a light source, such as a laser, is directed onto an analyte (or sample) that is to be chemically analyzed. A majority of the incident photons are elastically scattered by the analyte molecule. In other words, the scattered photons have the same energy, and thus the same frequency, as the photons that were incident on the analyte. However, a small fraction of the photons (i.e., about 1 in 10⁷ photons) are inelastically scattered by the analyte molecules. These inelastically scattered photons have a different frequency than the incident photons. This inelastic scattering of photons is termed the “Raman effect.” The inelastically scattered photons may have frequencies greater than, or, more typically, less than the frequency of the incident photons.

When an incident photon collides with a molecule, energy may be transferred from the photon to the molecule or from the molecule to the photon. When energy is transferred from the photon to the molecule, the scattered photon will emerge from the sample having a lower energy and a corresponding lower frequency. These lower-energy Raman scattered photons are commonly referred to in Raman spectroscopy as the “Stokes radiation.” A small fraction of the analyte molecules are already in an energetically excited state. When an incident photon collides with an excited molecule, energy may be transferred from the molecule to the photon, which will emerge from the sample having a higher energy and a corresponding higher frequency. These higher-energy Raman scattered photons are commonly referred to in Raman spectroscopy as the “anti-Stokes radiation.”

The Stokes and the anti-Stokes radiation is detected by a detector, such as a photomultiplier or a wavelength-dispersive spectrometer, which coverts the energy of the impinging photons into an electrical signal. The characteristics of the electrical signal are at least partially a function of the energy (or wavelength, frequency, wave number, etc.) of the impinging photons and the number of the impinging photons (intensity). The electrical signal generated by the detector can be used to produce a spectral graph of intensity as a function of frequency for the detected Raman signal (i.e., the Stokes and anti-Stokes radiation). A unique Raman spectrum corresponding to the particular analyte may be obtained by plotting the frequency of the inelastically scattered Raman photons against the intensity thereof. This unique Raman spectrum may be used for many purposes such as identifying an analyte, identifying chemical states or bonding of atoms and molecules in the analyte, and determining physical and chemical properties of the analyte. Raman spectroscopy may be used to analyze a single molecular species or mixtures of different molecular species. Furthermore, Raman spectroscopy may be performed on a number of different types of molecular configurations, such as organic and inorganic molecules in either crystalline or amorphous states.

Molecular Raman scattering of photons is a weak process. As a result, powerful, costly laser sources typically are used to generate high intensity excitation radiation to increase the weak Raman signal for detection. Surface-enhanced Raman spectroscopy (SERS) is a technique that allows for enhancement of the intensity of the Raman scattered radiation relative to conventional Raman spectroscopy. In SERS, the analyte typically is adsorbed onto or placed adjacent to what is often referred to as a SERS-active structure. SERS-active structures typically include a metal surface or structure. Interactions between the analyte and the metal surface may cause an increase in the intensity of the Raman scattered radiation.

Several types of metallic structures have been employed in SERS techniques to enhance the intensity of Raman scattered radiation that is scattered by an analyte. Some examples of such structures include electrodes in electrolytic cells, metal colloid solutions, and metal substrates such as a roughened metal surface or metal “islands” formed on a substrate. For example, it has been shown that adsorbing analyte molecules onto or near a specially roughened metal surface of gold or silver can enhance the Raman scattering intensity by factors of between 10³ and 10⁶.

Raman spectroscopy recently has been performed employing metal nanoparticles, such as nanometer scale needles, particles, and wires, as opposed to a simple roughened metallic surface. This process will be referred to herein as nano-enhanced Raman spectroscopy (NERS). Structures comprising nanoparticles that are used to enhance the intensity of Raman scattered radiation may be referred to as NERS-active structures. The intensity of the Raman scattered radiation that is scattered by an analyte adsorbed on such a NERS-active structure can be increased by factors as high as 10¹⁶. However, the intensity of the Raman scattered photons could be further increased if there was a method for forming NERS-active structures including nanoscale features having particular sizes, shapes, locations, and orientations. Also, difficulties in producing such NERS-active structures are impeding research directed to completely understanding the enhancement mechanisms, and therefore, the ability to optimize the enhancement effect. In addition, conventional NERS-active structures may require significant time and money to fabricate. If these problems can be overcome, the performance of nanoscale electronics, optoelectronics, and molecular sensors may be significantly improved.

### BRIEF SUMMARY OF THE INVENTION

The present invention, relates to NERS-active structures including features having nanoscale dimensions, methods for forming NERS-active structures and arranging nanoparticles, and systems for arranging nanoparticles.

In one embodiment of the present invention, a method of forming a plurality of NERS-active structures is disclosed. Particularly, a substrate having a surface may be provided and a liquid including a plurality of nanoparticles may be deposited on at least a portion of the surface of the substrate. Further, at least one electric field may be generated at least proximate to the surface and at least a portion of the plurality of nanoparticles may be arranged via the electric field.

In a further aspect of the present invention, a system for arranging nanoparticles includes a substrate having a surface and a plurality of nanoparticles within a liquid deposited on at least a portion of the surface of the substrate. Also, at least two electrodes may be operably coupled to at least one electrical source and configured for producing at least one electric field for substantially aligning at least a portion of the plurality of nanoparticles substantially according to a selected pattern.

Additionally, the present invention relates to a NERS-active structure. In one embodiment, a NERS active structure may include a substrate and a plurality of features located at predetermined positions on a surface of the substrate, wherein each feature of the plurality of features may have nanoscale dimensions and may be separated from one another by a predetermined distance of between about 1 and about 50 nanometers. Further, at least one feature of the plurality of features may include at least one NERS-active nanoparticle at least partially embedded therein.

The features, advantages, and alternative aspects of the present invention will be apparent to those skilled in the art from a consideration of the following detailed description taken in combination with the accompanying drawings.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1A shows a perspective view of a particular embodiment of a substrate including a liquid on a portion of a surface thereof, the liquid having a plurality of nanoparticles dispersed therein;

FIG. 1B shows a side view of the substrate shown in FIG. 1A, wherein two electrodes are positioned thereabout;

FIG. 1C shows a schematic, conceptualized side view of a representative polarized nanoparticle within an electric field;

FIG. 1D shows a schematic, conceptualized side view of a plurality of nanoparticles arranged generally along a line according to an embodiment of the invention;

FIG. 1E shows a top elevation view of the substrate shown in FIG. 1B wherein a plurality of nanoparticles is arranged along a plurality of substantially parallel reference lines;

FIG. 1F shows a side view of a nanoparticle affixed to a surface of a substrate according to the embodiment of the invention;

FIG. 2 shows a side view of a substrate as shown in FIG. 1B, including a vibrational source for communicating with nanoparticles within a liquid deposited upon a portion of a surface of the substrate;

FIG. 3A shows an enlarged, partial, simplified side view of a shaped electrode and another electrode for generating an electric field for arranging a plurality of nanoparticles according to an embodiment of the invention;

FIG. 3B shows an enlarged, partial, simplified side view of two shaped electrodes for generating an electric field for arranging a plurality of nanoparticles;

FIG. 3C shows a side view of a representative substrate having two shaped electrodes;

FIG. 4 a side view of a representative substrate having four electrodes;

FIG. 5A shows a top elevation view of a representative substrate having structures for intensifying an electric field proximate to a surface thereof and nanoparticles dispersed within a liquid and substantially aligned with the structures;

FIG. 5B shows a side view of the substrate shown in FIG. 5A;

FIG. 6A shows a top elevation view of a representative substrate having a non-planar surface wherein nanoparticles are aligned thereon;

FIG. 6B shows a side view of the substrate shown in FIG. 6A;

FIG. 6C shows a top elevation view of a representative substrate having a non-planar surface configured for facilitating alignment of nanoparticles wherein nanoparticles are aligned thereon;

FIG. 6D shows a side view of the substrate shown in FIG. 6C;

FIG. 7A shows a top elevation view of a representative substrate having a non-planar surface configured for facilitating alignment of nanoparticles;

FIG. 7B shows a conceptualized side view of the substrate shown in FIG. 7A;

FIGS. 8A-8C illustrate a simplified side view of a representative nanoimprinting process performed on a substrate having a plurality of arranged nanoparticles upon at least a portion of a surface thereof;

FIGS. 9A-9D illustrate a simplified side view of a representative nanoimprinting process performed on a substrate having a plurality of arranged nanoparticles upon at least a portion of a surface thereof, wherein a deformable layer is formed over the plurality of arranged nanoparticles 60;

FIGS. 10A-10D illustrate a simplified side view of a representative nanoimprinting process performed on a substrate having a plurality of arranged nanoparticles upon at least a portion of a surface thereof, wherein the nanoparticles are arranged upon a first deformable layer and a second deformable layer is formed thereover;

FIG. 11 shows a perspective view of a representative substrate including a plurality of exemplary NERS-active arrays comprising a plurality of exemplary protrusions; and

FIG. 12 shows a schematic diagram of an exemplary system for performing surface enhanced Raman spectroscopy.

### DETAILED DESCRIPTION OF THE INVENTION

The particular aspects of the present invention described herein are intended in all respects to be illustrative rather than limiting. The present invention relates to NERS-active structures including features having nanoscale dimensions and methods for forming such NERS-active structures. Accordingly, the methods and structures disclosed herein may allow for the fabrication of NERS-active structures including nanoscale features having well controlled size, shape, location, and orientation, which may also allow for substantial enhancement of a Raman scattered signal intensity relative to a conventional NERS-active structure.

Specifically, the present invention contemplates methods for arranging a plurality of nanoparticles on a surface of a substrate and methods relative thereto for forming NERS-active structures. “Nanoparticles,” as used herein, refers to particles having a nominal size of between about 2 nanometers to about 20 nanometers. Of course, some nanoparticles may have dimensions greater than or less than the dimensions of other nanoparticles. Further, while the process actions and structures described herein pertain to facilitating an understanding of the methods of the present invention, the process actions and structures described herein may omit portions of a complete process for forming a NERS-active structure. Therefore, the omitted portions of more complete processes for fabricating NERS are known to those of ordinary skill in the art.

Generally, in accordance with the present invention, an electrophoretic process may be employed for arranging nanoparticles upon a surface of a substrate. As known in the art, electrophoresis concerns the migration of particles suspended within a liquid in response to an electromotive force applied thereto. Particularly, a particle having an electrical charge will experience an electromotive force when positioned within an electrical field. For instance, a force upon a charged particle may be given by the following equation:

F=q*E

Wherein:

q is a magnitude of charge carried by a particle;

E is a magnitude of the electrical field; and

F is a force on the charged particle.

In one embodiment, a liquid including nanoparticles may be provided. For instance, at least one dielectric liquid (e.g., water, alcohol, or other dielectric liquid) and a plurality of nanoparticles (e.g., gold, silver, copper, platinum, palladium, aluminum, or any other material that will enhance the Raman scattering of photons, such as, e.g. materials with a relatively large high frequency dielectric constant such as silicon, silicon dioxide, titanium dioxide, zirconium dioxide and others) may be provided. Further, the dielectric liquid, including the plurality of nanoparticles, may be applied over at least a portion of a surface of the substrate for forming NERS-active structures thereon.

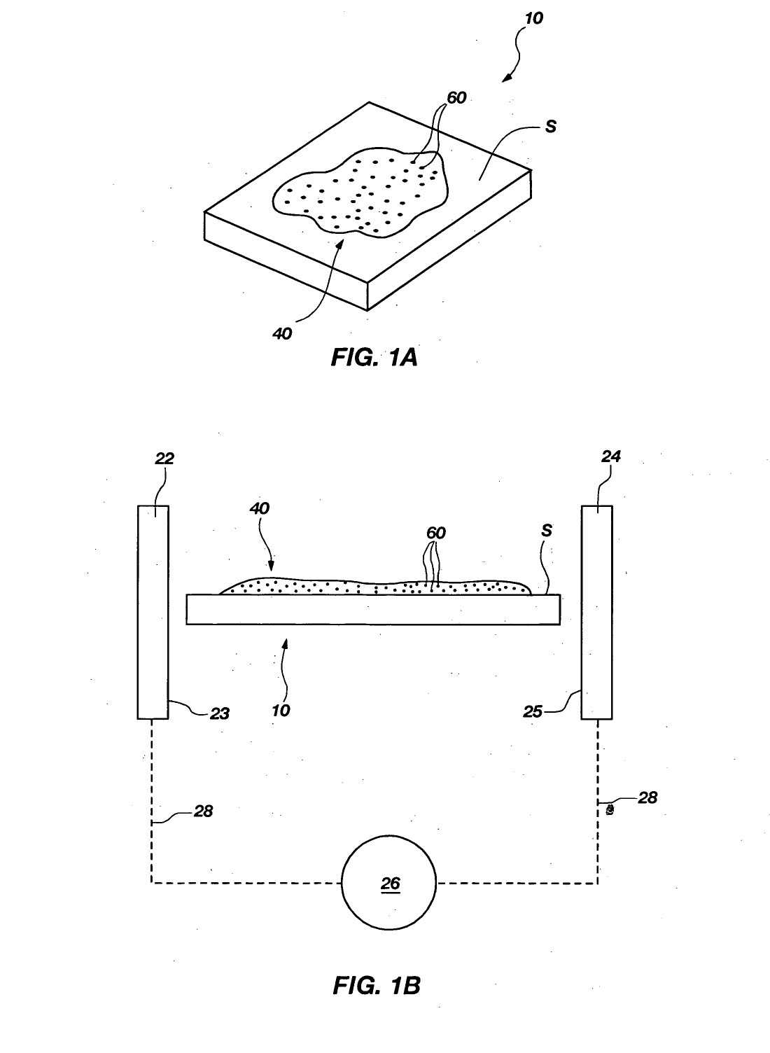

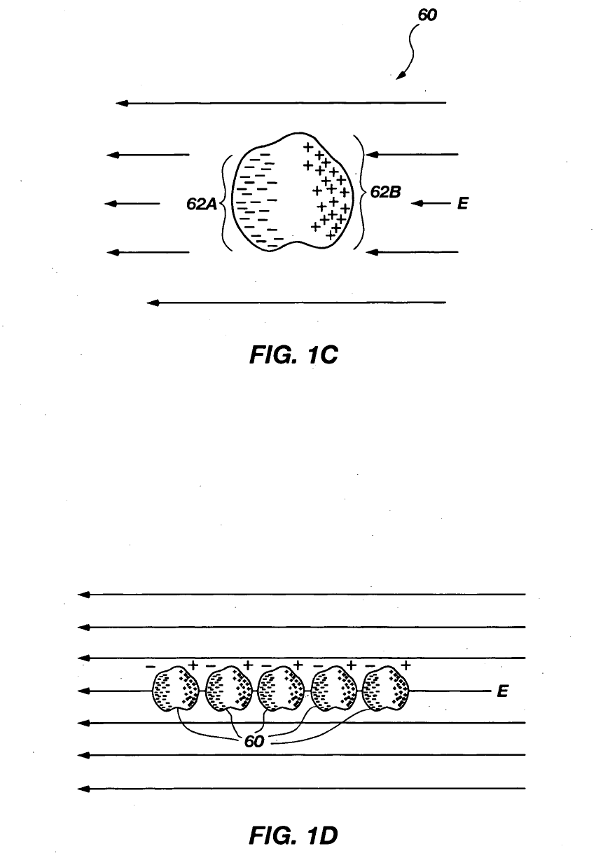

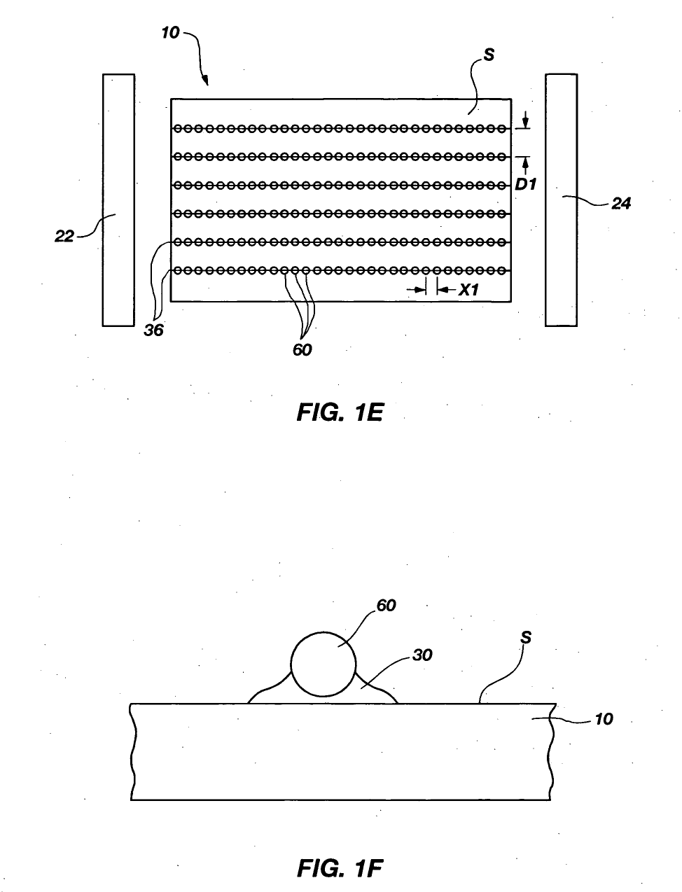

For example, FIGS. 1A-1D illustrate various techniques according to a particular embodiment of the present invention for arranging nanoparticles on at least a portion of a surface of a substrate. Particularly, FIG. 1A shows a perspective view of a substrate 10 provided with a dielectric liquid 40, including nanoparticles 60. For instance, the dielectric liquid 40 may be applied to at least a portion of a surface S of the substrate 10 by way of spin-coating, spraying, doctor blade coating techniques, screen printing techniques, dispensing techniques, dipping, or as otherwise known in the art.

Substrate 10 may comprise, for example, silicon, other semiconductor materials, ceramics, plastics, metals, or any other suitable material. Nanoparticles 60 may comprise a NERS-active material such as, for example, gold, silver, copper, platinum, palladium, aluminum, or any other material that may enhance the Raman scattering of photons.

In one embodiment, each of the plurality of nanoparticles 60 may exhibit a substantially spherical geometry having a diameter D of between about 2 and about 20 nanometers. In addition, some nanoparticles 60 may have dimensions greater than or less than the dimensions of other nano-particles 60. However, the shape and size of each of nanoparticles 60 may be predetermined, selected, and controlled during fabrication. In addition, at least a portion of nanoparticles 60 may be positioned substantially according to a selected, predetermined pattern. While one embodiment of the present invention contemplates that nanoparticles 60 comprise a metal, the present invention is not so limited. Rather, nanoparticles 60 may be non-metallic, non-conductive, or both. However, it should be recognized that if nanoparticles 60 comprise a dielectric material, less effective polarization may be exhibited in comparison to the poloarization that would be exhibited if nanoparticles 60 were electrically conductive (e.g., formed of a metal) for a given magnitude of electric field.

It should also be understood that nanoparticles 60 may comprise more than one distinguishable size, shape, or composition, without limitation. For instance, nanoparticles 60 may include at least two different nanoparticles. For instance, nanoparticles 60 may comprise at least two of gold, silver, copper, platinum, palladium, and aluminum. Further, nanoparticles 60 may include two or more distinct size ranges and may also include structures such as nanorods.

Additionally, the present invention further contemplates that at least one electric field may be imposed for causing electrophoretic alignment of the nanoparticles 60 within the dielectric liquid 40 applied over or upon at least a portion of a surface S of the substrate 10. The at least one electrical field may be imposed proximate to, generally upon, or through a selected deposition surface S of the substrate 10 and for influencing the arrangement of nanoparticles 60 with respect thereto. More specifically, at least one electric field may be configured for causing nanoparticles 60 to arrange generally upon or proximate at least a portion of a surface S of substrate 10, as described in greater detail hereinbelow.

In one embodiment, at least two electrodes may be provided for generating an electric field for arranging nanoparticles 60. For example, FIG. 1B shows a side view of substrate 10 including a dielectric liquid 40 having nanoparticles 60 disposed therein and electrodes 22 and 24 positioned at opposite ends of the substrate 10. Electrodes 22 and 24 may include substantially planar surfaces 23 and 25, wherein each substantially planar surface is oriented toward one another and substantially parallel to one another. Such a configuration of electrodes 22 and 24 may produce a substantially uniform electrical field therebetween upon applying a voltage difference therebetween. One of electrodes 22 and 24 may be electrically connected to a positive voltage source of a battery or other electrical source, and the other of electrodes 22 and 24 may be electrically grounded or may be connected to a negative of the battery or other electrical source.

Although conventional electrophoretic deposition techniques may typically employ two electrodes in contact with a liquid including a particle for deposition, the present invention contemplates that electrodes 22 and 24 may, as shown in FIG. 1B, not contact dielectric liquid 40. Alternatively, at least one of electrodes 22 and 24 may contact dielectric liquid 40. It may be appreciated that different configurations relating to contact or non-contact of at least one of electrodes 22 and 24 may be selected with respect to specific characteristics of at least one of nanoparticles 60, dielectric liquid 40, and substrate 10.

As further shown in FIG. 1B, a voltage difference may be applied between electrodes 22 and 24 by way of electrical source 26. Electrical source 26 may be configured for providing an electrical signal (e.g., voltage, etc.) between electrodes 22 and 24. The electrical source 26 may be configured for supplying a time-varying electrical signal (i.e., alternating) or a substantially time-invariant or constant electrical signal intermittently or continuously, without limitation. The present invention further contemplates that the electrical signal applied between electrodes 22 and 24 may be selected for arranging nanoparticles 60 preferentially upon substrate 10.

In response to an electrical field extending between electrodes 22 and 24, nanoparticles 60 may acquire, in effect, a negative charge on a region thereof nearest the positive electrode and a positive charge on a region thereof nearest the negative electrode in response to an electrical field therebetween. For example, FIG. 1C shows a schematic, conceptualized side view of a nanoparticle 60 under the influence of an electrical field E, wherein region 62A is slightly negatively charged (denoted by a “−” sign), while region 62B is slightly positively charged (denoted by a “+” sign).

Such an effect may be termed “polarization” and it occurs, for example, because the atoms within nanoparticle 60 are made up of separate electric charges, namely positive nuclei and negative electrons. Thus, under the influence of an electric field, the electrons and nuclei may be biased slightly toward oppositely charged, respective electrodes, so that the center of the overall negative charge does not coincide with the center of the overall positive charge (i.e., polarization). For example, in certain embodiments, the nanoparticle 60 molecule may have a dipole (where the molecule has non-uniform distributions of positive and negative charges) and polarization and movement or rotation of the molecule may be generated under an electrical field. The amount of polarization produced by a given electric force (i.e., the “polarizability”) may vary widely for different materials, but all materials may be influenced to some degree.

Further, such polarization of nanoparticles 60 may cause localized arrangement of nanoparticles 60 in alternating adjacent relationships that form elongated strings, as shown in FIG. 1D. FIG. 1D shows a schematic, conceptualized side view of a plurality of nanoparticles 60, wherein a positively charged region (denoted by a “+” sign) of one nanoparticle 60 is positioned adjacent a negatively charged region (denoted by a “−” sign) of another nanoparticle 60.

In one embodiment, such alignment of nanoparticles 60 may facilitate formation of strings or lines of nanoparticles 60 along reference lines 36, as shown in FIG. 1E. FIG. 1E shows a top elevation view of substrate 10 and nanoparticles 60 arranged thereon. An electric field formed between electrodes 22 and 24 may be conceptually represented by field gradient lines that are substantially parallel with reference lines 36. Put another way, the electric field (gradient lines) may form boundary surfaces that extend substantially traverse to the surface S of the substrate at a position proximate thereto. An electric field formed between electrode 22 and 24 may be substantially therebetween, or, alternatively, as discussed in further detail hereinbelow, may be non-uniform, without limitation.

Nanoparticles 60 may be arranged according to any pattern, as desired, without limitation. Further, utilizing an electric field for arranging a plurality of nanoparticles may exhibit alignment thereof having a dimensional tolerance of less than about 5 nanometers with respect thereto. For example, FIG. 1E shows nanoparticles 60 arranged along a plurality of substantially mutually parallel reference lines 36. In further detail, nanoparticles 60 may be arranged along a plurality of substantially mutually parallel reference lines 36 that may be substantially equally spaced from one another. Alternatively, at least some of the plurality of reference lines 36 may be unequally spaced from other adjacent reference lines of the plurality of reference lines. Also, a spacing distance D1 between adjacent substantially mutually parallel reference lines 36 of the plurality of substantially mutually parallel reference lines 36 (whether equally spaced or unequally spaced) may be between about 0.5 nanometers and about 5 nanometers. Further, localized forces between nanoparticles 60 (e.g., polarization forces) may influence the spacing distance X1 between adjacent nanoparticles 60.

Spacing D1 between substantially mutually parallel reference lines 36 may also be influenced by localized electrical repulsive forces (e.g., polarization forces) between proximate polarized nanoparticles 60. Explaining further, regions 62A, 62B of one or more polarized nanoparticles 60 exhibiting the same charge (positive or negative) in proximity to one another may, at least to some extent, repulse one another, which may promote the formation of elongated strings or lines of nanoparticles 60 to form or arrange under the influence of an electric field. Thus, the precise spacing D1 between adjacent substantially mutually parallel reference lines 36 and spacing X1 between adjacent nanoparticles 60 may be influenced, at least in part, by a relative strength or magnitude of an electric field extending between electrodes 22 and 24 and the specific electrical characteristics of the polarized nanoparticles 60.

As may be appreciated, excess nanoparticles 60, other than those that may substantially fill the desired pattern upon substrate 10 (e.g., a plurality of substantially parallel reference lines 36), within dielectric liquid 40, may agglomerate or otherwise interfere with arrangement of at least some of nanoparticles 60 upon at least a portion of a surface S of substrate 10. Accordingly, an amount or number of nanoparticles 60 within dielectric liquid 40 may be selected so as to not exceed an estimated amount or number of nanoparticles 60 that may be at least substantially arranged according to a selected pattern upon at least a portion of a surface S of substrate 10. Thus, limiting an overall number or amount of nanoparticles may facilitate arrangement thereof without substantial disruption or interference due to excessive numbers of nanoparticles 60 than may be required to substantially fill a desired or selected pattern.

Once nanoparticles 60 are aligned at least substantially according to a selected arrangement or pattern, dielectric liquid 40 may evaporate, leaving nanoparticles 60 positioned substantially according to the selected arrangement or pattern. However, nanoparticles 60 may be substantially free to move without an electric field of other mechanism for retaining the position of the arranged nanoparticles. Thus, nanoparticles 60 may be optionally affixed to the surface S of substrate 10 as arranged substantially according to the selected arrangement or pattern. For example, an impurity or other dissolved substance or material within dielectric liquid 40 may bond nanoparticles 60 to substrate 10 as dielectric liquid 40 evaporates. Optionally, an electric field may be applied during evaporation of at least a portion of dielectric liquid 40 for maintaining the position of nanoparticles 60.

More particularly, FIG. 1F shows a conceptualized side view of a portion of substrate 10 including nanoparticle 60 bonded to surface S of substrate 10 by adhesive material 30. It should be appreciated that adhesive material 30 need not comprise a traditional adhesive such as an epoxy, glue, or other conventional adhesive. Rather, adhesive material may comprise any material that provides resistance to the movement of nanoparticles 60 subsequent to the electric field being eliminated.

Alternatively or additionally, as discussed in greater detail hereafter, a layer of material for affixing nanoparticles 60 to surface S of substrate 10 may be deposited over substantially arranged nanoparticles 60 for affixing nanoparticles 60 to substrate 10. In a further alternative, at least a portion of dielectric liquid 40 may be at least partially cured or hardened for affixing nanoparticles 60 to a surface S of substrate 10. For instance, dielectric liquid may comprise a photopolymer, an epoxy, or another hardenable or curable material as known in the art.

During affixation of nanoparticles 60 to surface S of substrate 10, an electric field may be produced or experienced by nanoparticles 60, for maintaining the arrangement thereof during affixation to substrate 10. For instance, an electric field may be applied to nanoparticles 60 continuously or intermittently during affixation (e.g., evaporation of the dielectric liquid 40 or other affixation) of nanoparticles 60 to substrate 10. Alternatively, an electric field may not be necessary subsequent to substantially arranging nanoparticles 60, depending on the affixation technique employed.

It may be appreciated that NERS-active structures may comprise nanoparticles arranged upon at least a portion of a surface of a substrate, if such a configuration is desirable. Alternatively, as discussed hereinbelow in greater detail, additional geometric features may be formed for improving the enhancement of a Raman-scattered signal.

In a further aspect of the present invention, an additional or different external influence other than the force due to a selected electric field for arranging nanoparticles 60 may be experienced by the nanoparticles 60 for facilitating alignment thereof. Put another way, it may be desirable to perturb nanoparticles 60 during arrangement of nanoparticles 60 (i.e., generally under the influence of a selected electric field or intermittently therewith). Such perturbation may facilitate movement of nanoparticles 60 by an electric field and within fluid 40. Accordingly, perturbation of nanoparticles 60 may cause alignment or arrangement thereof in a relatively rapid manner.

In one example, the electric field for aligning nanoparticles 60 may be perturbed or varied from a selected or desired electric field for aligning nanoparticles 60. That is, the strength, polarity, frequency (if any), or another characteristic of the electric field for aligning nanoparticles 60 may be varied in relation to a selected or desired electric field for aligning or causing nanoparticles 60 to align. For example, an electric field having selected characteristics may be generated for aligning nanoparticles 60. As discussed hereinbelow, an additional electric field may be imposed upon nanoparticles 60 for facilitating arrangement thereof. Alternatively, one electric field may be intermittently varied in relation to a different selected electric field for arranging nanoparticles 60. Such a configuration may be effective in influencing a portion of nanoparticles 60 that would not otherwise respond (i.e., align) if only the selected electric field were applied.

Alternatively or additionally, vibrational energy may be communicated to nanoparticles 60 for promoting alignment or arrangement thereof over or upon at least a portion of a surface S of substrate 10. For instance, the present invention contemplates that vibrational energy may be communicated indirectly to nanoparticles 60 by vibrating at least one of the substrate 10 and the dielectric liquid 40 while an electric field is imposed between electrodes 22 and 24.

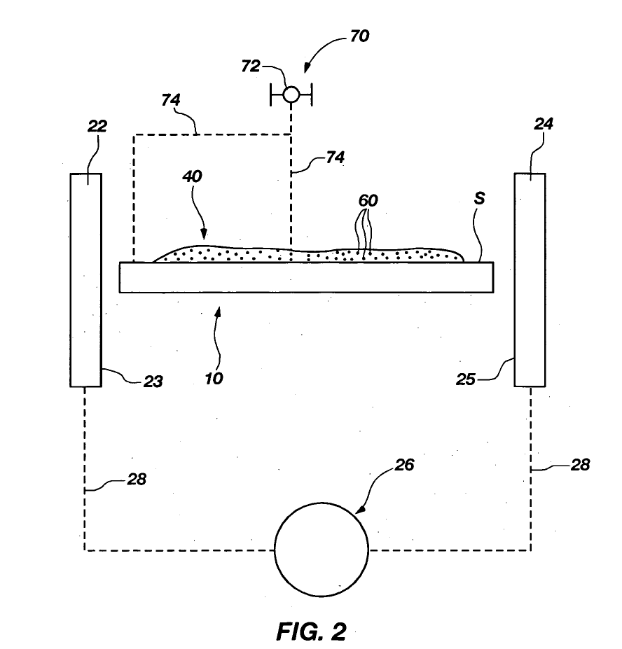

Accordingly, as shown in FIG. 2, a vibration system 70 may be structurally coupled to at least one of the substrate 10 and the dielectric liquid 40. Vibration system 70 may include vibration generator 72, which may comprise a motor configured for rotating a mass having a center of mass and is positioned eccentrically with respect to the rotational axis of the motor. Vibration generator 72 is structurally coupled to at least one of substrate 10 and the dielectric liquid 40 via transmission element(s) 74. Alternatively, an ultrasonic or acoustic vibration apparatus and a suitable coupling to at least one of the substrate 10 and the dielectric liquid 40 may be employed, as known in the art, without limitation. Vibration f nanoparticles 60 may be desirable for facilitating alignment thereof while under the influence of an electrical field applied between electrodes 22 and 24.

Accordingly, as may be appreciated by the above-described embodiments, configuration of at least one electric field may substantially determine the pattern with which polarized nanoparticles may become substantially aligned therewith. Therefore, the present invention contemplates that an electrical field proximate the surface of the substrate may be configured for facilitating a selected arrangement of nanoparticles thereon. Particularly, at least one electrical field may be tailored or configured for aligning nanoparticles in a selected pattern or alignment template. Optionally, a plurality of electrical fields may be generated for alignment of nanoparticles according to a selected pattern or alignment template.

In one embodiment for generating an electric field for aligning nanoparticles in a selected pattern or alignment template, at least one electrode may be shaped so as to promote alignment of nanoparticles in a selected arrangement. Explaining further, preferential shaping of at least one electrode may be employed for producing a non-uniform electrical field proximate to a surface of substrate 10, which may facilitate alignment of nanoparticles thereon or thereover.

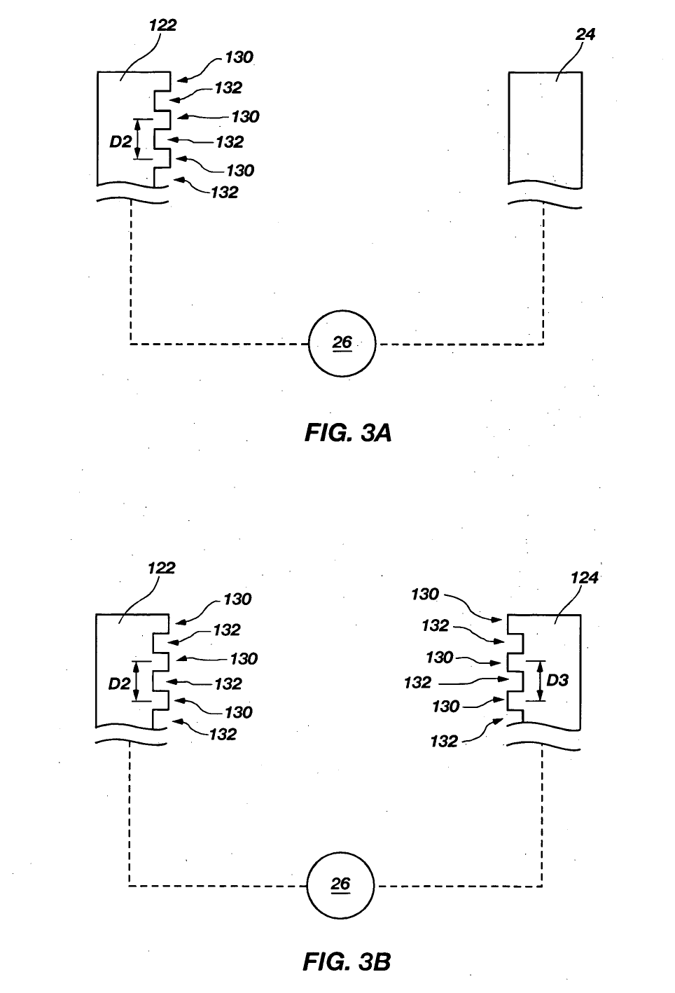

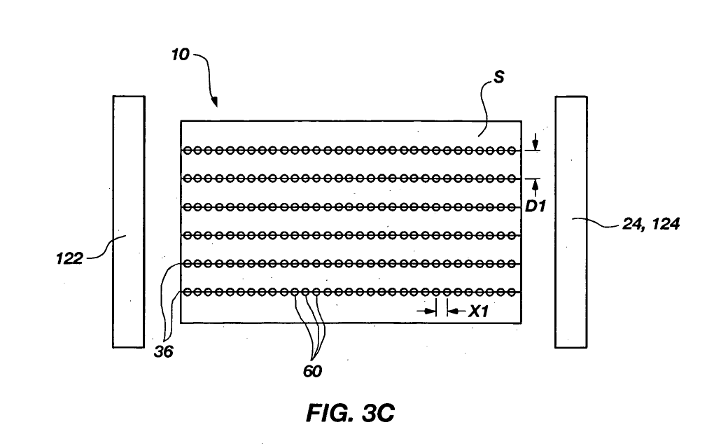

Referring to FIG. 3A a simplified, enlarged top view of a portion of electrodes 122 and 24 is shown, wherein electrode 122 exhibits a topography that is oriented toward electrode 24 for generating relatively stronger regions of the electric field and relatively weaker regions of the electric field. Particularly, electrode 122 may include alternating protruding regions 130, positioned with respect to one another according to a spacing D2, which represents a distance between respective centers (i.e., centroids of the side cross-sectional areas, respectively) of alternating protruding regions 130. Further, alternating protruding regions 130 may be laterally adjacent to recessed regions 132. Further, the protruding regions 130 may be structured (e.g., sized and configured) for producing an electric field between electrodes 122 and 24 having relatively stronger electrical field regions therebetween. Further, relatively stronger electric field regions may correspond to a desired pattern or template for arranging nanoparticles with respect thereto. Such a configuration may promote a relatively stronger electric field in at least one region that preferentially attracts or arranges polarized nanoparticles proximate thereto, to a greater degree than in at least one other region having a relatively weaker electric field.

Alternatively, FIG. 3B shows a simplified, enlarged top view of a portion of electrodes 122 and 124. Both electrodes 122 and 124 may exhibit topographies which are sized, configured, and positioned with respect to one another for generating relatively stronger regions of an electric field for arranging nanoparticles upon at least a portion of surface of substrate. Optionally protruding regions 130 of electrodes 122 and 124 may be, optionally, substantially aligned with one another so that protruding regions 130 face one another and recessed regions 132 face one another. Such a configuration may produce relatively stronger regions of an electric field between the substantially aligned, protruding regions 130 of electrodes 122 and 124, respectively.

Referring to FIG. 3C, a top elevation view of electrode 122 and electrode 24 or 124 is shown wherein nanoparticles 60 are arranged along a plurality of substantially mutually parallel reference lines 36. Spacing distance D1 between adjacent substantially mutually parallel reference lines 36 of the plurality of substantially mutually parallel reference lines 36 (whether equally spaced or unequally spaced) may substantially correspond spacing D2 between adjacent protruding regions 130 of electrode 122. Further, a spacing distance D1 between substantially mutually parallel reference lines 36 may be between about 0.5 nanometers and about 5 nanometers. Thus, it may be appreciated that selection of spacing distances D2 and D3 (FIG. 3B) of electrodes 122 or 124 may influence the spacing distance X1 between adjacent nanoparticles 60 that are aligned with respect to an electric field generated therebetween.

Of course, electrical field behavior between two or more electrodes may be simulated or modeled as known in the art (e.g., by computer simulation). Additionally, behavior of nanoparticles within at least one electric field may be simulated or modeled. In one example, finite element analysis or other electrical field simulation or predictive mechanism may be employed for predicting or simulating the behavior of at least one electrical field for arranging nanoparticles, behavior of nanoparticles therein, or both.

In another aspect of the present invention, a plurality of electrical fields may be employed for arranging nanoparticles. For example, the present invention contemplates that more than two electrodes for producing at least two electrical fields may be structured, positioned, and oriented as desired, without limitation, for causing or promoting arrangement of nanoparticles in a selected pattern or arrangement.

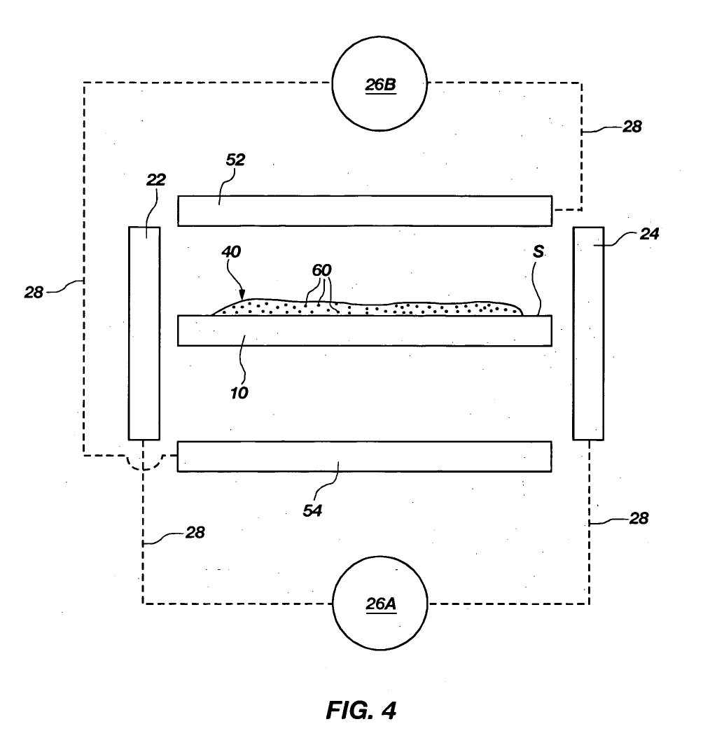

For example, as shown in FIG. 4, electrodes 22, 24, 52 and 54 may be positioned relative to substrate for generating an electric field proximate at least a portion of a surface S of the substrate 10 upon which nanoparticles 60 are to be arranged. Such a configuration may allow relative flexibility in configuring a desired electrical field for substantially arranging nanoparticles 60 in relation thereto.

In yet a further aspect of the present invention, the substrate itself may be structured for intensifying or strengthening an electric field proximate thereto and for arranging nanoparticles with respect thereto. In other words, at least a portion of a substrate may be structured for influencing an applied electric field for arranging nanoparticles on a surface of the substrate.

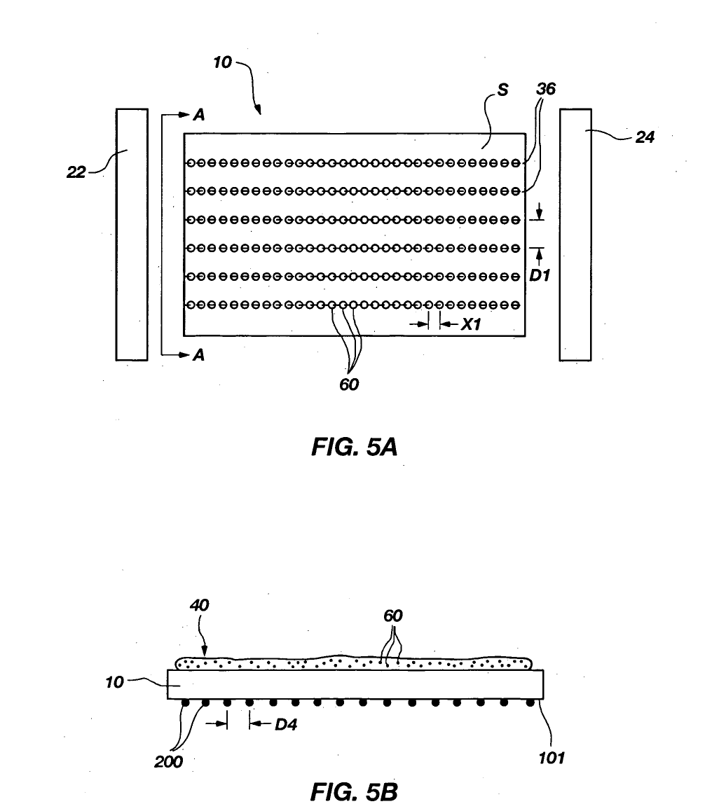

In one exemplary embodiment, a substrate 10 may comprise a dielectric material and may include electrically conductive material configured as a plurality of substantially parallel traces or lines 36 as shown in FIG. 5A. FIG. 5B shows an end view along reference line A-A of FIG. 5A toward substrate 10. As shown in FIG. 5B, an electrically conductive material 200 (e.g., a metal) may be deposited on a surface 101 of substrate 10. Particularly, electrically conductive material 200 may be deposited upon substrate 10 and configured for intensifying an electrical field proximate to surface S of substrate 10 so as to arrange nanoparticles 60 thereon. In another exemplary embodiment, the electrically conductive material 200 may be embedded inside of the substrate 10, such as, for example, underneath surface S of substrate 10.

Electrically conductive material 200 may be deposited upon surface 101 of substrate 10 according to any process known in the art. For example, suitable deposition methods include electron-beam lithography techniques, etching, atomic layer deposition techniques, nanoimprinting techniques, electrophoretic deposition techniques, physical vapor deposition (PVD), atomic layer deposition (ALD), chemical vapor deposition (CVD), low pressure chemical vapor deposition (LPCVD), plasma enhanced chemical vapor deposition (PECVD), electron beam evaporation, vacuum evaporation, sputtering, and plating.

Electrically conductive material 200 may intensify or otherwise enhance an electric field configured for arranging nanoparticles 60. Thus, nanoparticles 60 may align substantially according to the pattern formed by electrically conductive material 200 on surface 101. Thus, as shown in FIG. 5A, nanoparticles 60 may become substantially aligned with the plurality of substantially parallel traces or lines 36 of electrically conductive material 200. However, although electrically conductive material 200 is shown in FIG. 5B as a series of separated, substantially parallel traces or lines 36, such a configuration is merely one exemplary embodiment. Electrically conductive material 200 may be configured in any pattern or design upon surface S of substrate 10 as desired, without limitation.

For instance, electrically conductive material 200 may be patterned so as to form a grid pattern comprising a first plurality of substantially mutually parallel lines that at least partially intersect with a second plurality of substantially mutually parallel lines. In one embodiment, the first plurality of substantially mutually parallel lines may be substantially perpendicular to the second plurality of substantially mutually parallel lines. Other embodiments may include electrically conductive material 200 deposited and patterned so as to form multiple closed plane figures, such as, for example, circles, triangles, or rectangles.

Such a configuration may provide a relatively robust and simple method of arranging nanoparticles. In addition, relatively complex arrangements or patterns may be employed for arranging nanoparticles that may otherwise be difficult to achieve by employing electrical fields alone.

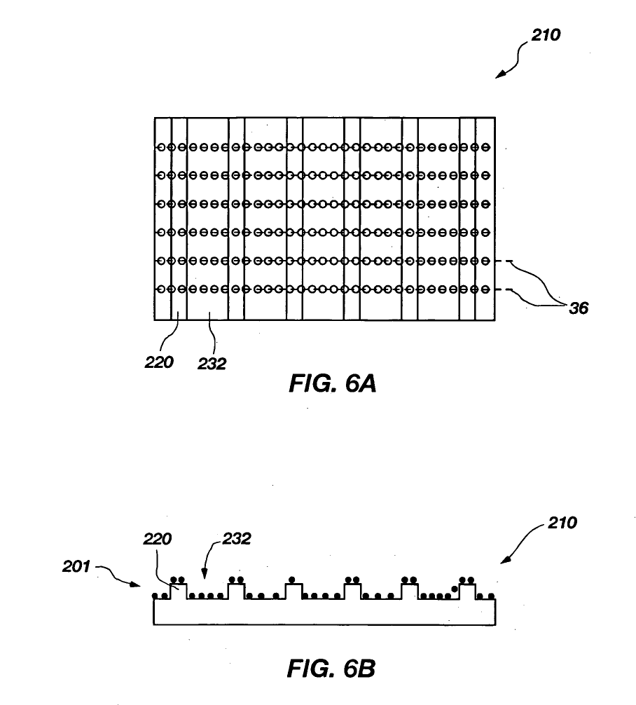

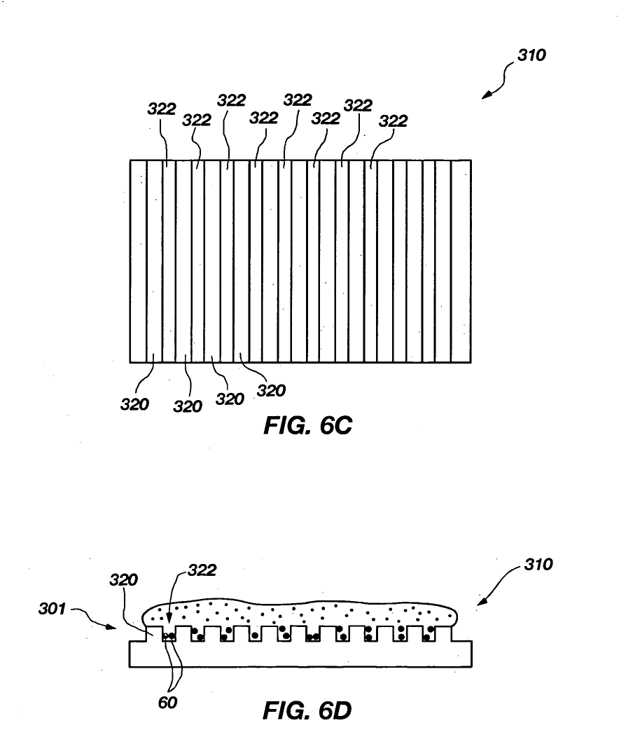

In a further aspect of the present invention, a surface of a substrate onto which nanoparticles are to be deposited may have a selected, non-planar topography prior to arranging a plurality of nanoparticles thereon or thereover. For instance, as shown in FIG. 6A, substrate 210 may include a surface comprising a plurality of alternating protruding regions 220 and recessed regions 232 upon which nanoparticles 60 are arranged.

The surface 201 (FIG. 6B) may be formed by way of nanoimprint technology, e-beam lithography, or any suitable method known in the art. In a particular embodiment, features such as protruding regions 220 and recessed regions 232 may have dimensions of between about 1 nanometers to about 50 nanometers. In further detail, each protruding region 220 may include a substantially elongated rectangular structure having a lateral width of between about 1 and about 50 nanometers, and a height of between about 1 and about 50 nanometers. Additionally, recessed regions may each have a lateral width of between about 1 and about 50 nanometers. For example, the lateral widths of each of protruding regions 220 and the lateral widths of each of recessed regions 232 may be between about 5 and about 15 nanometers.

Such a configuration may provide a method by which nanoparticles 60 may be positioned at different distances in relation to surface 201 of substrate 210. As may be appreciated, such structures may form NERS-active structures useful for the enhancement of a Raman scattered signal intensity.

In yet another aspect of the present invention, a surface of a substrate onto which nanoparticles are to be deposited may have a selected, non-planar topography for facilitating selective arrangement of nanoparticles. For example, as shown FIG. 6C, substrate 310 may include a surface comprising a plurality of alternating protruding regions 320 and recessed regions 322 upon which nanoparticles 60 are arranged. Such a configuration may provide a method by which nanoparticles 60 may be positioned generally within recessed regions 322 (i.e., between protruding regions 320).

An electric field may be generated at least proximate to surface 301 of substrate 310 for arranging nanoparticles 60 generally within recessed regions 322. For instance, FIG. 6D shows a side view of substrate 310 as shown in FIG. 6C, illustrating nanoparticles 60 positioned generally within recessed regions 322. An electric field may be configured for aligning nanoparticles 60 generally within recessed regions 322.

Further, protruding regions 320 and recessed regions 322 may be configured for positioning nanoparticles 60, as shown in FIG. 6D. A lateral width and a height of protruding regions 320, as well as a lateral width of recessed regions 322, may be selected in relation to a desired size or shape of nanoparticle 60 for arrangement. For example, a lateral width of between about 1 and about 50 nanometers, a height of between about 1 and about 50 nanometers, and a lateral width of between about 1 and about 50 nanometers may be selected. For example, the lateral widths of each of recessed regions 322 may be selected so that, at most, one nanoparticle 60 may be accepted between adjacent protruding regions 320. Alternatively, lateral widths of each of recessed regions 322 may be selected so that a plurality of nanoparticles 60 may be accepted between adjacent protruding regions 320. Also, height may be selected for accommodating (e.g., vertically, as shown in FIG. 6D) a selected number of nanoparticle(s) 60 (e.g., one or more). Such a configuration may be advantageous for forming NERS-active structures having specific configurations.

The present invention further contemplates that an electric field may be preferentially positioned and oriented with respect to a surface of a substrate for promoting alignment and arrangement of nanoparticles thereon. In one embodiment, an electrical field may be positioned and oriented with respect to a topographical feature of a substrate.

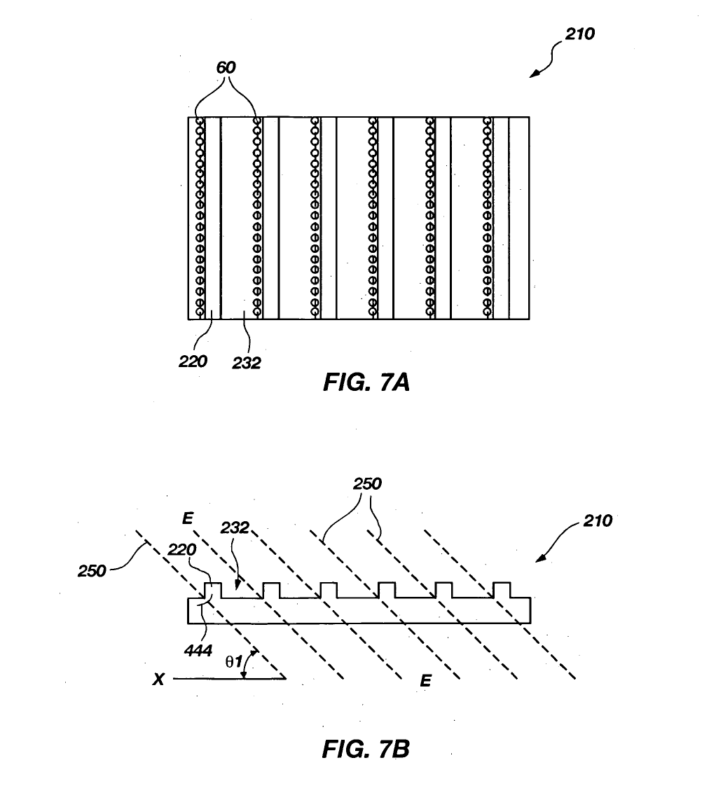

As shown in FIGS. 7A and 7B, electric field E may be oriented (referring to field lines 250, represented by dashed lines in FIG. 7B and oriented at an angle θ1 with respect to axis X) so as to pass generally through substrate 10 proximate to meeting line region 444 formed between a sidewall of each of protruding regions 220 and an adjacent recessed region 232, respectively. Put another way, electric field may be oriented non-perpendicularly with respect to substantially planar surface of substrate 210. Such a configuration may substantially align nanoparticles 60 (shown in FIG. 7A only, for clarity) proximate to the meeting line region 444. Also, such a configuration may be desirable for producing NERS-active structures having selected properties and characteristics.

Further, alignment or arrangement of nanoparticles may be repeated upon a substrate having previously arranged nanoparticles on at least a portion of a surface thereof. Of course, additional deposition, etching, nanoimprinting, or other topographical modification techniques may be employed for forming NERS-active structures according to desired configurations. Such repetition may allow for substantial alignment of a subsequent nanoparticle pattern or template with respect to a first plurality of arranged nanoparticles.

Thus, according to the above-described methods, at least a portion of a plurality of nanoparticles may be substantially aligned or arranged with respect to a substrate surface. Such a configuration may be desirable for forming NERS-active structures. Optionally, a plurality of arranged nanoparticles on a surface of a substrate may form a NERS-active structure suitable for use within a NERS process. Alternatively, additional processing, topographical feature formation, or other material deposition or removal may be performed subsequent to arranging nanoparticles upon or over a surface of a substrate.

For example, one method for forming topographical features into a surface of a substrate, (so-called nanoimprinting) may optionally be performed subsequent to alignment of nanoparticles 60 thereon. As discussed above, the present invention also contemplates that nanoimprinting may be performed into a substrate, prior to alignment of nanoparticles thereon, for forming non-planar features thereon. Representative nanoimprinting techniques suitable for use in the present invention are described in U.S. Pat. No. 6,432,740 to Chen, assigned to the assignee of the present invention, the disclosure of which is incorporated in its entirety by reference herein.

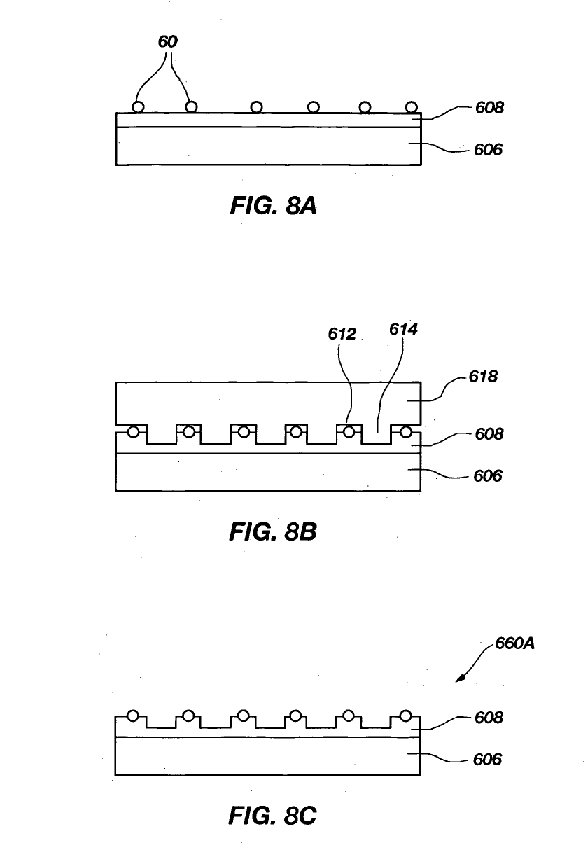

FIGS. 8A-8C illustrate a nanoimprinting process subsequent to alignment of nanoparticles 60 upon a core layer 606. For instance, referring to FIG. 8B, a nanoimprint mold 618 may be formed from, for example, silicon, other semiconductor materials, ceramics, plastics, metals, or any other suitable material. A series of protrusions 614 and recesses 612 (FIG. 8B) may be formed in a surface of the mold 618 using electron beam lithography, reactive ion etching or any other suitable method known in the art. The size, shape, location, and orientation of the protrusions 614 may be substantially identical or form a precursor for a desired size, shape, location, and orientation of a plurality of features of a NERS-active structure 660A, as shown in FIG. 8C.

A NERS-active structure substrate 660A may initially include nanoparticles 60 arranged upon at least a portion of a surface of a deformable layer 608 comprising a deformable material which may be applied to a surface of a core layer 606 (FIG. 8A). The deformable layer 608 of deformable material may comprise a thermoplastic polymer, such as, for example polymethylmethacrylate (PMMA). The thickness of the deformable layer 608 may be approximately equal to, or slightly greater than, the height of the features of the NERS-active structure to be formed (i.e., between about 1 and about 50 nanometers). Alternatively, the deformable layer 608 may include many other organic, inorganic, or hybrid materials that will deform under pressure of the mold 618 and that can be further processed as described hereinbelow.

As shown in FIG. 8B, the nanoimprint mold 618 may be pressed against the deformable layer 608 such that the protrusions 614 of the nanoimprint mold 618 are pressed thereinto. As known in the art, the deformable layer 608 may be softened by heating the deformable layer 608 to a temperature above a glass transition temperature of the material prior to pressing the mold 618 against the deformable layer 608. Accordingly, the protrusions 614 and recesses 612 of the mold 618 may form corresponding recesses and protrusions in the deformable layer 608, as shown in FIG. 8C.

Further, the mold 618 may be removed subsequent to cooling the deformable layer 608 to a temperature below the glass transition temperature of the material comprising the deformable layer 608. Alternatively, the mold 618 may be removed prior to cooling the deformable layer 608 of deformable material if the deformable layer 608 will maintain its shape (i.e., maintain the recesses 622 and protrusions 624) until the temperature of the deformable layer 608 drops below the glass transition temperature of the material comprising the deformable layer 608.

Thus, as may be appreciated with respect to FIGS. 8A-8C, a NERS-active nanoparticle may be at least partially encapsulated within a geometric feature of a nanoimprinted deformable layer. Such a process may be desirable for producing NERS-active structures. Further, such NERS-active structures may be specifically structured and positioned for interaction with one or more specific analyte molecules.

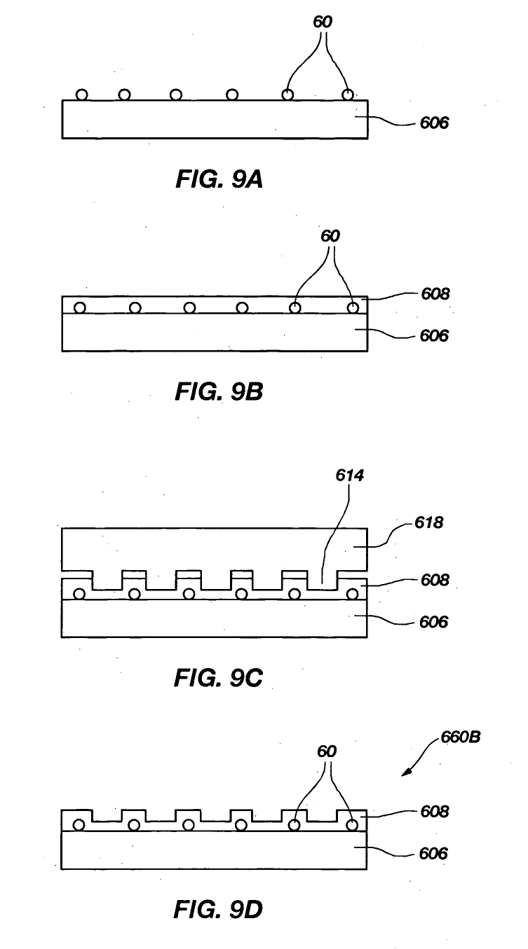

Alternatively, as illustrated in FIGS. 9A-9D, the nanoparticles 60 may be arranged upon a core layer 606 prior to deformable layer 608 being deposited thereon. Particularly, as shown in FIG. 9A, nanoparticles 60 may be arranged upon at least a portion of a surface of a surface of core layer 606. Further, as shown in FIG. 9B, a deformable layer 608 comprising a deformable material may be applied to a surface of core layer 606. As shown in FIG. 9C, and as described above in relation to FIG. 8B, the nanoimprint mold 618 may be pressed against the deformable layer 608 such that the protrusions 614 of the nanoimprint mold 618 are pressed into the deformable layer 608. Thus, the plurality of protrusions 614 may form a plurality of features (or precursors thereof) of a NERS-active structure 660B, as shown in FIG. 9D.

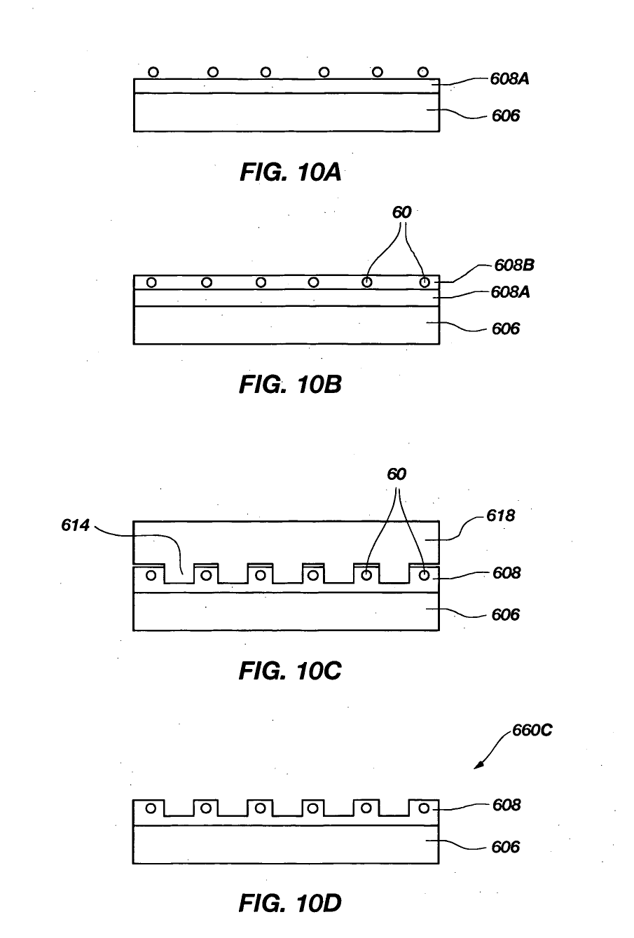

Of course, one or more deformable layers may be configured for positioning of at least one nanoparticle, as desired within a protrusion, as shown in FIGS. 10A-10D. For example, as shown in FIGS. 10A-10D, a first deformable layer 608A may be deposited upon core layer 606. Then, nanoparticles 60 may be arranged upon at least a portion of a surface thereof. Further, a second deformable layer 608B (FIG. 10B) may be formed over the first deformable layer 608A at least partially encapsulating the nanoparticles 60 therein. As shown in FIG. 10C, the nanoimprint mold 618 may be pressed against the deformable layer 608 (comprising both first deformable layer 608A and second deformable layer 608B) such that the protrusions 614 of the nanoimprint mold 618 are pressed into the deformable layer 608. Thus, the plurality of protrusions 614 may form a plurality of features (or precursors thereof) of a NERS-active structure 660C may be formed, as shown in FIG. 10D.

Optionally, with regard to NERS-active structures 660A, 660B, and 660C, as shown in FIGS. 8C, 9D, and 10D, respectively, at least a portion of the patterned (nanoimprinted) deformable layer 608 may be removed or further shaped by, for example, etching (e.g., reactive ion etching or chemical etching), if desired. Subsequent to further processing, if any, the NERS-active structure 660 may be used in a NERS system to enhance the Raman signal of an analyte (not shown). Thus, as may be appreciated by the above discussion, the present invention may provide a method for the production of a NERS-active structure where the size, shape, location, and orientation of the features of the NERS-active structures 660A, 660B, and 660C may be well controlled. The features of the NERS-active structures 660A, 660B, and 660C may have dimensional tolerances of less than about 5 nanometers, and the features of the NERS-active structures 660A, 660B, and 660C may allow for the production of multiple, substantially identical NERS-active structures.

Generally, nanoimprinting a substrate having a plurality of arranged nanoparticles may form an array of protrusions at predetermined locations on a surface of the substrate. More particularly, an array of protrusions may be formed in the surface of the substrate that exhibit predetermined dimensions for enhancing the Raman-scattered signal emitted by an analyte. Further, the present invention contemplates that other techniques for forming structures upon a substrate may be employed prior to or subsequent to arranging a plurality of nanoparticles upon or over a surface of a substrate. For example, electron-beam lithography, etching techniques, or other techniques as known in the art may be employed for forming structures, including nanoparticles arranged, at least in part, by way of electrophoresis.

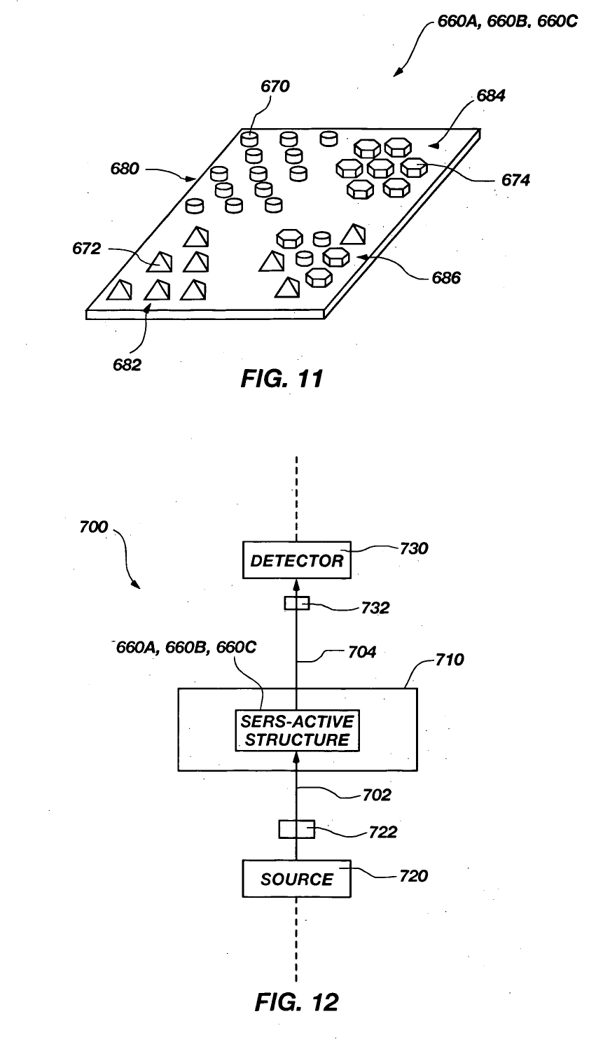

For example, as shown in FIG. 11, an array of protrusions may ultimately form an array 682 of substantially pyramidal protrusions 672, array 684 of substantially hexagonal protrusions 674, an array 680 of substantially cylindrical protrusions 670, or an array 686 including combinations thereof, without limitation. Further, each protrusion 670, 672, and 674 of an array 680, 682, 684, and 686 may be separated from one another by a distance of between about 1 and about 50 nanometers.

Furthermore, a NERS process may be performed with a NERS-active structure formed by processes of the present invention. For instance, an exemplary NERS system 700 that may include any of the exemplary NERS-active structures 660A, 660B or 660C formed according to the methods described above may be used to perform surface enhanced Raman spectroscopy. as illustrated schematically in FIG. 12. The NERS system 700 may include a sample or analyte stage 710, an excitation radiation source 720, and a detector 730. The analyte stage 710 may include a NERS-active structure 660A, 660B, 660C and may also include various optical components 722 positioned between the excitation radiation source 720 and the analyte stage 710, and various optical components 732 positioned between the analyte stage 710 and the detector 730.

The excitation radiation source 720 may include any suitable source for emitting radiation at the desired wavelength and may be capable of emitting a tunable wavelength of radiation. For example, commercially available semiconductor lasers, helium-neon lasers, carbon dioxide lasers, light emitting diodes, incandescent lamps, and many other known radiation emitting sources may be used as the excitation radiation source 720. The wavelengths that are emitted by the excitation radiation source 720 may be any suitable wavelength for properly analyzing the analyte molecules using NERS. An exemplary range of wavelengths that may be emitted by the excitation radiation source 720 includes wavelengths between about 350 nm and about 1000 nm.

The excitation radiation 702 emitted by the source 720 may be delivered either directly from the source 720, to the analyte stage 710 and NERS-active structure 660A, 660B or 660C. Alternatively, collimation, filtration, and subsequent focusing of excitation radiation 702 may be performed by optical components 722 before the excitation radiation 702 impinges on the analyte stage 710 and NERS-active structure 660A, 660B or 660C.

Analyte molecules may be provided adjacent the NERS-active structures 660A, 660B or 660C to enhance the intensity of Raman scattered radiation when the NERS-active structures and the analyte molecules are irradiated with excitation radiation. The Raman scattered photons 704 may be collimated, filtered, or focused with optical components 732. For example, a filter or a plurality of filters may be employed, either as part of the structure of the detector 730, or as a separate unit that is configured to filter the wavelength of the excitation radiation 702, thus, allowing only the Raman scattered photons 704 to be received by the detector 730. Thus, the detector 730 may receive and detect the Raman scattered photons 704 and may include a monochromator (or any other suitable device for determining the wavelength of the Raman scattered photons 704) and a device such as, for example, a photomultiplier for determining the quantity of Raman scattered photons (intensity).

Accordingly, it may be appreciated that the methods disclosed herein may allow for the reproducible formation of NERS-active structures including nanoscale features having well controlled size, shape, location, and orientation. In turn, these structures may allow for improved surface-enhanced Raman spectroscopy. The performance of nanoscale electronics, optoelectronics, molecular sensors, and other devices employing the Raman effect may be significantly improved by using the NERS-active structures disclosed herein. In addition, the methods disclosed herein may allow for production of high quantities of NERS-active structures at relatively low cost.

The methods and systems disclosed herein may also be utilized for forming NERS-active structures to perform hyper-Raman spectroscopy. Hyper-Raman spectroscopy relates to a very small number of photons that may be scattered at frequencies corresponding to the higher order harmonics of the excitation radiation in response to excitation radiation impinging on an analyte molecule. For example, radiation exhibiting frequencies of second and third harmonics (i.e., twice or three times the frequency) of the excitation radiation may be scattered in response to excitation radiation impinging on an analyte molecule. Some of these higher frequency photons may have a frequency that is Raman-shifted relative to the frequencies corresponding to the higher order harmonics of the excitation radiation. These shifted, higher order Raman-scattered photons may provide information about the analyte molecule that cannot be obtained by first order Raman spectroscopy. Hyper-Raman spectroscopy involves the collection and analysis of these higher order Raman-scattered photons.

Although the foregoing description contains many specifics, these are not to be construed as limiting the scope of the present invention, but merely as providing certain exemplary embodiments. Accordingly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims are encompassed by the present invention.

What is claimed is:

1. A method of arranging a plurality of nanoparticles, comprising:
providing a substrate having a surface;
depositing a liquid including a plurality of nanoparticles on at least a portion of the surface of the substrate;
generating at least one electric field proximate to the surface; and
arranging at least a portion of the plurality of nanoparticles via the electric field.

2. The method of claim 1, wherein arranging at least the portion of the plurality of nanoparticles comprises arranging at least the portion of the plurality of nanoparticles according to a selected pattern.

3. The method of claim 2, wherein arranging at least the portion of the plurality of nanoparticles according to the selected pattern comprises arranging at least the portion of the plurality of nanoparticles within a dimensional tolerance of less than about 5 nanometers relative to the selected pattern.

4. The method of claim 2, wherein providing the liquid including the plurality of nanoparticles comprises providing a plurality of nanoparticles comprising a NERS-active material.

5. The method of claim 4, wherein providing the plurality of nanoparticles comprising a NERS-active material comprises providing a plurality of nanoparticles comprising at least one of the metals silver, gold, and copper, platinum, palladium, and aluminum, or of dielectric materials such as silicon, silicon dioxide, titanium dioxide, zirconium dioxide, or other dielectric with a large high frequency dielectric constant.

6. The method of claim 1, wherein depositing the liquid including the plurality of nanoparticles on at least the portion of the surface of the substrate comprises depositing a dielectric liquid including the plurality of nanoparticles on at least the portion of the surface of the substrate.

7. The method of claim 1, wherein generating the at least one electric field at least proximate to the surface comprises providing at least two electrodes and energizing the at least two electrodes with an electrical signal.

8. The method of claim 1, further comprising communicating vibrational energy to the plurality of nanoparticles while arranging of at least the portion of the plurality of nanoparticles by influencing at least the portion of the plurality of nanoparticles via the electric field.

9. The method of claim 1, wherein generating the at least one electric field at least proximate to the surface comprises generating a substantially uniform electric field proximate to the surface of the substrate.

10. The method of claim 1, wherein generating the at least one electric field at least proximate to the surface comprises generating a non-uniform electric field proximate to the surface of the substrate.

11. The method of claim 1, wherein providing the substrate comprises providing at least one conductive structure proximate the surface of the substrate for intensifying the at least one electrical field.

12. The method of claim 1, wherein providing the substrate having the surface comprises providing the substrate having a non-planar surface.

13. The method of claim 1, further comprising affixing the at least some of the plurality of nanoparticles to the substrate.

14. The method of claim 1, further comprising:
providing a nanoimprint mold;
forming an array of recesses at predetermined locations on a surface of the nanoimprint mold, the recesses having nanoscale dimensions; and
pressing the nanoimprint mold against the substrate, the array of recesses in the surface of the nanoimprint mold forming an array of corresponding protrusions extending from the substrate.

15. The method of claim 14, further comprising:
heating the substrate prior to the step of pressing the nanoimprint mold against the surface thereof; and
cooling the substrate subsequent to the step of pressing the nanoimprint mold against the surface thereof.

16. A method of arranging a plurality of nanoparticles, comprising:
providing a substrate having a surface;
depositing a liquid including a plurality of nanoparticles on at least a portion of the surface of the substrate;
arranging at least a portion of the plurality of nanoparticles by generating an electromotive force upon the at least a portion of the plurality of nanoparticles.

17. A system for arranging nanoparticles, comprising:
a substrate having a surface;
a plurality of nanoparticles within a liquid deposited on at least a portion of the surface of the substrate; and
at least two electrodes operably coupled to at least one electrical source and configured for producing at least one electric field for substantially aligning at least a portion of the plurality of nanoparticles according to a selected pattern.

18. The system of claim 17, wherein the at least two electrodes are configured for arranging at least the portion of the plurality of nanoparticles substantially according to the selected pattern within a dimensional tolerance of less than about 5 nanometers with respect thereto.

19. The system of claim 17, wherein the substrate includes at least one conductive structure proximate the surface of the substrate for intensifying the at least one electrical field.

20. The system of claim 17, further comprising a vibrational source for communicating vibrational energy to the plurality of nanoparticles within the liquid deposited on at least the portion of the surface of the substrate.

21. The system of claim 17, wherein the surface of the substrate is non planar.

22. The system of claim 21, wherein the non planar surface of the substrate is configured for facilitating placement of the at least some of the plurality of nanoparticles.
